(19) United States
(12) Patent Application Publication
(10) Pub. No.: US 2009/0260568 A1
(43) Pub. Date: Oct. 22, 2009

(54) GLUE DISPENSER AND GLUE DISPENSING PROCESS

(75) Inventor: Hsin-Hung Chuang, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/273,701

(22) Filed: Nov. 19, 2008

(30) Foreign Application Priority Data
Apr. 18, 2008 (CN) 200810301210.9

(51) Int. Cl. B05C 11/00

(52) U.S. Cl. 118/666

(57) ABSTRACT

An exemplary glue dispenser for dispensing a glue on a workpiece includes a nozzle for dispensing the glue on the workpiece, a working platform for supporting a workpiece thereon, and a heating device mounted on the working platform. The heating device is configured for maintaining the workpiece in an elevated temperature, which is higher than a temperature of the glue.

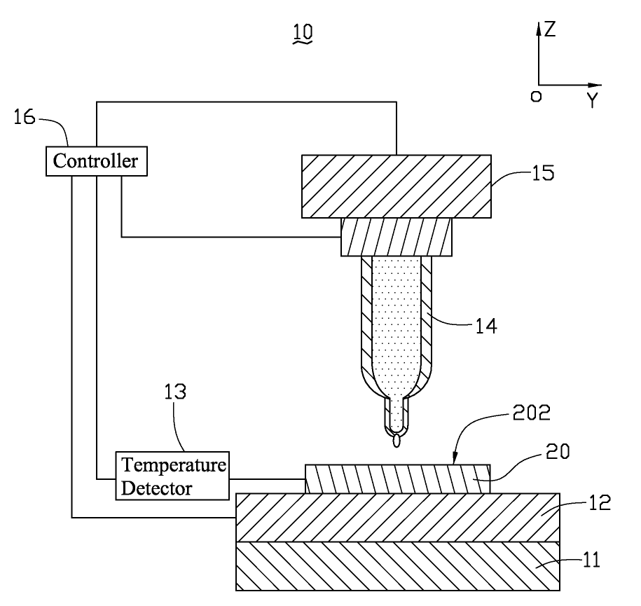

### BACKGROUND

1. Technical Field

The present invention relates generally to dispensers for glue, adhesive, or the like, and dispensing processes using such dispensers.

2. Description of Related Art

Nowadays, lens modules have been widely employed in various electronic devices (e.g., mobile phones) for image capturing. Generally, a lens module includes a lens barrel, a lens group, a spacer, and a filter (e.g., IR-cut filter). In assembly, the lens group, the spacer and the filter are assembled into the lens barrel and arranged along an optical axis thereof, in an order from an object side to an image side of the lens module. The filter is bonded with the spacer via a glue. The glue is deposited on a bonding surface of the spacer by a glue dispenser. After the filter coupled to the spacer via the glue, the lens module is placed into an oven, and then baked to achieve a complete solidification. Thus, the filter is firmly attached to the spacer. However, the baking and solidification processes are usually time-consuming. Accordingly, the efficiency of assembling the lens module is low.

Therefore, a new glue dispenser and a new dispensing process are desired to overcome the above mentioned problems.

### SUMMARY

An exemplary glue dispenser for dispensing a glue on a workpiece includes a nozzle for dispensing the glue on the workpiece, a working platform, and a heating device mounted on the working platform for supporting a workpiece thereon. The heating device is configured for maintaining the workpiece in an elevated temperature higher than a temperature of the glue.

### BRIEF DESCRIPTION OF THE DRAWING

Many aspects of the embodiment can be better understood with references to the following drawing. The components in the drawing are not necessarily drawn to scale, the emphasis instead being placed upon clearly illustrating the principles of the present embodiment. Moreover, in the drawing, like reference numerals designate corresponding parts throughout the several views.

The FIGURE is a schematic, cross-sectional view of a glue dispenser, according to an exemplary embodiment.

### DETAILED DESCRIPTION OF THE EMBODIMENT

The embodiment will now be described in detail below with reference to the drawing.

Referring to the FIGURE, a glue dispenser 10 for dispensing glue to a workpiece 20 according to an exemplary embodiment is shown.

The glue dispenser 10 includes a working platform 11, a heating device 12, a temperature detector 13, a nozzle 14, a driving device 15, and a controller 16.

The heating device 12 is mounted on a surface of the working platform 11, and faces the nozzle 14. The heating device 12 is configured for supporting and heating the workpiece 20. The heating device 12 is connected with the controller 16. The controller 16 controls the heating device 12 to heat/maintain the workpiece 20 at an elevated temperature. The elevated temperature is higher than a temperature of a glue in the nozzle 14. In particular, the elevated temperature is 5° C.-20° C. higher than the temperature of the glue. The heating device 12 can be a resistance heater.

The temperature detector 13 is configured for detecting the temperature of the workpiece 20 and sending a corresponding signal to the controller 16. A first end of the temperature detector 13 is electrically connected with the controller 16, while a second end of the temperature detector 13 is thermally connected with the workpiece 20. When the temperature of the workpiece 20 is lower than the elevated temperature, the controller 16 turns on the heating device 12, and then the heating device 12 heats up the workpiece 20. When the temperature of the workpiece 20 is higher than the elevated temperature, the controller 16 turns off the heating device 12, and then the heating device 12 stops heating up the workpiece 20. The temperature detector 13 can be a thermally sensitive resistance, a thermal couple, a resistance temperature detector (RTD), or a temperature detection integrated circuit (IC).

The nozzle 14 is arranged on the driving device 15. The nozzle 14 is configured for depositing a glue on the workpiece 20. The nozzle 14 is connected with the controller 16. The controller 16 determines the amount of glue to be dispensed from the nozzle 14 and a glue dispensing rate of the nozzle 14.

The driving device 15 is configured for driving the nozzle 14 to move along X, Y and Z axes (X axis not shown) of a Cartesian coordinate. The driving device 15 is connected to the controller 16. The controller 16 controls the movement of the driving device 15, and then the driving device 15 drives the nozzle 14 to move towards or away from the workpiece 20.

In addition, the glue dispenser 10 can further includes a red signal light and a green signal light (not shown) electrically connected with the controller 16. When the temperature of the workpiece 20 is lower than the elevated temperature, the red signal light turns on. When the temperature of the workpiece 20 is higher than the elevated temperature, the green signal light turns on.

In operation, the workpiece 20 is firstly fixedly mounted on the heating device 12, thermally connected to the second end of the temperature detector 13, and heated up to the elevated temperature. Secondly, the glue is deposited on a surface 202 of the workpiece 20 via the nozzle 14. In this step, the glue is pre-solidified because the elevated temperature of the workpiece 20 is higher than a temperature of the glue. Thirdly, another workpiece (not shown) is placed on the surface 202 of the workpiece 20 and pressed downwardly towards the workpiece 20. Fourthly, the assembly of the two workpieces is placed into an oven, and baked to achieve a complete solidification. Since the glue has been pre-solidified before baked in the oven, it takes less time to bake and solidify the glue.

While certain embodiments have been described and exemplified above, various other embodiments from the foregoing disclosure will be apparent to those skilled in the art. The present invention is not limited to the particular embodiments described and exemplified but is capable of considerable variation and modification without departure from the scope of the appended claims.

What is claimed is:

1. A glue dispenser for dispensing a glue on a workpiece, comprising:
a nozzle for dispensing the glue on the workpiece;
a working platform for supporting the workpiece thereon; and
a heating device mounted on the working platform and configured for maintaining the workpiece at an elevated temperature, the elevated temperature being higher than a temperature of the glue.

2. The glue dispenser as claimed in claim 1, further comprising a controller, wherein the controller is electrically connected with the heating element, and is configured for controlling the heating element.

3. The glue dispenser as claimed in claim 2, further comprising a temperature detector configured for detecting a temperature of the workpiece, wherein the temperature detector is electrically connected with the controller, and is for thermally connecting with the workpiece.

4. The glue dispenser as claimed in claim 1, further comprising a controller, wherein the controller is coupled to the nozzle, and is configured for controlling a glue dispensing rate of the nozzle.

5. The glue dispenser as claimed in claim 1, further comprising a driving device for driving the nozzle to move toward and away from the workpiece.

6. The glue dispenser as claimed in claim 5, further comprising a controller connected with the driving device and configured for controlling movement of the driving device.

7. A glue dispenser for dispensing a glue on a workpiece, comprising:
a controller;
a nozzle for dispensing a glue on a workpiece, the nozzle being connected with the controller;
a working platform for supporting the workpiece thereon;
a heating device mounted on the working platform and electrically connected with the controller, the heating device being configured for maintaining the workpiece at an elevated temperature, the elevated temperature being higher than a temperature of the glue; and
a temperature detector configured for detecting a temperature of the workpiece, wherein the temperature detector is electrically connected with the controller, and r is for thermally connecting with the workpiece.

8. The glue dispenser as claimed in claim 7, further comprising a driving device for driving the nozzle to move toward and away from the workpiece, wherein the controller is connected with the driving device, and is configured for controlling movement of the driving device.

9. A dispensing process for applying a glue onto a workpiece, the process comprising:
heating a workpiece to an elevated temperature, the elevated temperature being higher than a temperature of the glue; and
applying the glue onto the workpiece.

10. The dispensing process as claimed in claim 9, wherein the workpiece is heated up to an elevated temperature which is 5° C.-20° C. higher than the temperature of the glue.
